(19) United States
(12) Patent Application Publication
(10) Pub. No.: US 2021/0056651 A1
(43) Pub. Date: Feb. 25, 2021

(54) Artificial Intelligence Driven Worker Training And Skills Management System

(71) Applicant: Accenture Global Solutions Limited, Dublin (IE)

(72) Inventors: Srijata Sengupta, Bangalore (IN); Shantiprakash Motwani, Thane West (IN); Joydeep Mukherjee, Redmond, WA (US); Sailaja Bhagavatula, Bangalore (IN); Shantha Maheswari, Bangalore (IN); Priya Ramdev, New Delhi (IN); Ashok Vira, Mumbai (IN); Mallika Haria, Mumbai (IN); Aditya Bhushan, Bengaluru (IN); Shubha Ramakrishnan, Mumbai (IN); Jayant Swamy, Bangalore (IN)

(21) Appl. No.: 16/549,685

(22) Filed: Aug. 23, 2019

(51) Int. Cl. G06Q 50/20; G06Q 10/06

(52) U.S. Cl. CPC G06Q 50/2057; G06Q 10/06398

(57) ABSTRACT

The present disclosure relates to a system, computer readable medium, and method for training workers in occupational skills. The disclosure provides highly automated, artificial intelligence driven, ways of improving human capital through the acquisition, development, and verification of multiple career related proficiencies. Generally, the disclosure provides an integrated digital platform that allows workers to (1) receive training on their existing job skills, (2) verify mastery of the existing job skills through various assessments, and (3) receive recommendations regarding which job skills may be useful to acquire.

### TECHNICAL FIELD

The present disclosure generally relates to managing workers in a professional environment. More specifically, the present disclosure generally relates to systems, methods, and computer readable medium for training, developing, and managing the occupational skills held by various workers across a large workforce. Even more specifically, the present disclosure relates to highly automated, artificial intelligence driven ways of improving human capital through the data-driven acquisition, development, and verification of multiple career related proficiencies.

### BACKGROUND

In the modern workplace, increasingly rapid technological advances may often present challenges for workers who desire to maintain cutting-edge professional skills. Workers may often have to adapt existing skills in new ways, and develop new skills, just to keep pace with job requirements and customer expectations.

This may present challenges for both the workers, and also for management. In many organizations today, workers are often responsible for their own career development and skill acquisition. This burden often comes on top of the substance of the worker's already existing workload. Conversely, management also faces difficulty in deploying its workforce in the most effective manner. Often, organizations may require many levels of management in order to best match workers with certain skills to appropriate projects or customers. This may present cost and logistical challenges, especially to large professional organizations.

In this way, there exists a technical problem of how to best track, develop, and promote acquisition of human capital professional skills among a large and diverse workforce. With a more data-rich environment, and with advances in machine learning, organizations could better manage and improve their stock of human capital.

Accordingly, there is a need in the art for a system and method that addresses the shortcomings discussed above.

### SUMMARY OF THE DISCLOSURE

The disclosure provides highly automated, artificial intelligence driven ways of improving human capital through the data-driven acquisition, development, and verification of multiple career related proficiencies. This disclosure addresses the problem of how to thoroughly manage the many career skills held by various people within a professional organization and encourage those people to continue to develop additional skills, by abstracting trends within the organization through the use of skill recommendation models.

Specifically, for example, features related to comparing the user profile with the multiple additional user profiles in the skillset database to determine one or more recommended skills for the worker to add to their user profile solve a technical problem of how to provide feedback and guidance to workers in a large professional organization based on professional skill trends within the organization. Also, for example, features related to providing a proficiency test output descriptive of a proficiency test corresponding to the professional skill inputted solve a technical problem of how to verify the human capital professional skills held by each worker within a large organization, so that verification may be done at a large scale in a consistent manner. By using these features, and all of the features disclosed herein, an organization may ensure that its people maintain relevant and cutting-edge skillsets so as to best adapt to the needs of an ever changing marketplace.

In one aspect, this disclosure provides an artificial intelligence driven system for training and managing workers in a professional organization, the system comprising at least one computing device, the computing device including a processor; and wherein the computing device is configured to perform the steps of: (1) receiving a skill input descriptive of a professional skill held by at least one worker; (2) associating the skill input with a user profile for the at least one worker; (3) storing the skill input as associated with the user profile in a skillset database, the skillset database including multiple additional user profiles with respective associated skill inputs; (4) providing a proficiency test output descriptive of a proficiency test corresponding to the professional skill inputted; (5) receiving a result of the proficiency test and associating the result of the proficiency test with the user profile; (6) comparing the user profile with the multiple additional user profiles in the skillset database to determine one or more recommended skills for the worker to add to their user profile; and (7) sending an output to the worker of the one or more recommend skills.

In another aspect, the disclosure provides a method of using artificial intelligence for training and managing workers in a professional organization, the method comprising: (1) receiving from a worker a skill input, descriptive of a professional skill held by the worker; (2) receiving from the worker a skill descriptor input from the worker for each skill input, descriptive of whether the skill inputted is a primary skill or a secondary skill; (3) generating a user profile for the worker, and associating the skill input and skill descriptor with the user profile; (4) storing the user profile in a skillset database, the skillset database further including multiple secondary user profiles as their associated skill inputs and skill descriptors; (5) sending a proficiency test output to the worker, descriptive of a proficiency test corresponding to the professional skill inputted; (6) receiving a result of the proficiency test and associating the result of the proficiency test with the user profile; (7) generating and sending a learning output to the worker, the learning output being descriptive of one or more training opportunities corresponding to the professional skill; (8) generating a recommended skills output by comparing the user profile with the secondary user profiles in the skillset database that have the same primary skill as the user profile; and (9)sending the recommended skills output to the worker.

Finally, in another aspect, this disclosure provides One or more non-transitory computer readable storage media encoded with instructions that, when executed by a processor of a computing device, causes the processor to: (1) receive a skill input, descriptive of a professional skill held by at least one worker; (2) receive a skill descriptor input from the worker for each skill input, descriptive of whether the skill inputted is a primary skill or a secondary skill; (3) generate a user profile for the worker, and associate the skill input and skill descriptor with the user profile; (4) store the user profile in a skillset database, the skillset database further including multiple secondary user profiles as their associated skill inputs and skill descriptors; (5) generate a recommended skills output by comparing the user profile with the secondary user profiles in the skillset database that have the same primary skill as the user profile, the recommended skills output being descriptive of one or more skills not already associated with the user profile; and (6) send the recommended skills output to the worker.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 shows an overview of a system for training and managing workers in a professional organization according to an embodiment;

FIG. 2 shows a flowchart of various steps and inputs in a first process for training and managing workers in a professional organization according to an embodiment;

FIG. 3 shows a flowchart of various steps and inputs in a first process for generating a recommended skills output according to an embodiment;

FIG. 4 shows a flowchart of various steps and inputs in a second process for generating a recommended skills output according to an embodiment;

FIG. 5 shows a diagrammatic overview of a process for combining several different models of generating a recommended skills output into one final output according to an embodiment;

FIG. 6 shows a scatter diagram of several user profiles and their associated primary skills in a database according to an embodiment;

FIG. 7 is a data table of example skills recommendations and the associated model scoring according to an embodiment;

FIG. 8 is an example output displaying several recommended skills;

FIG. 9 shows a flowchart of a process for testing the proficiency of a worker in relation to a professional skill according to an embodiment;

FIG. 10 shows a flowchart of a process for testing a worker across multiple levels of proficiency for a skill according to an embodiment;

FIG. 11 shows an example output displaying training opportunities associated with a skill according to an embodiment;

FIG. 12 shows a flowchart of a process that includes proficiency testing, training opportunities, and skills recommendation all together in one embodiment.

### DETAILED DESCRIPTION

Generally, this disclosure uses data-driven artificial intelligence to provide human capital skills development. By so doing, this disclosure allows workers and management to effectively maintain, verify, and develop professional skills in the context of a large professional organization. Further details of the several aspects of this disclosure are discussed variously below.

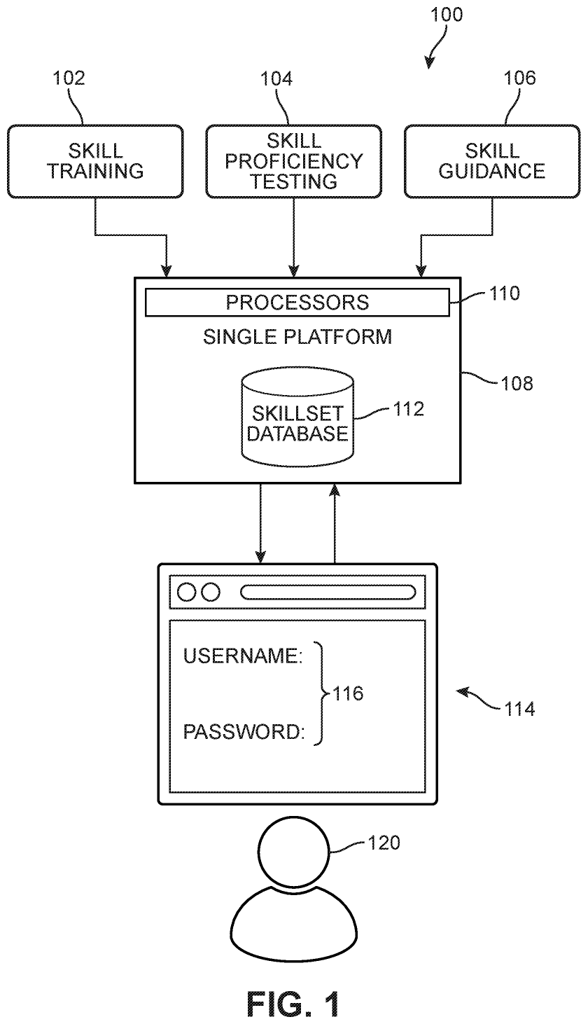

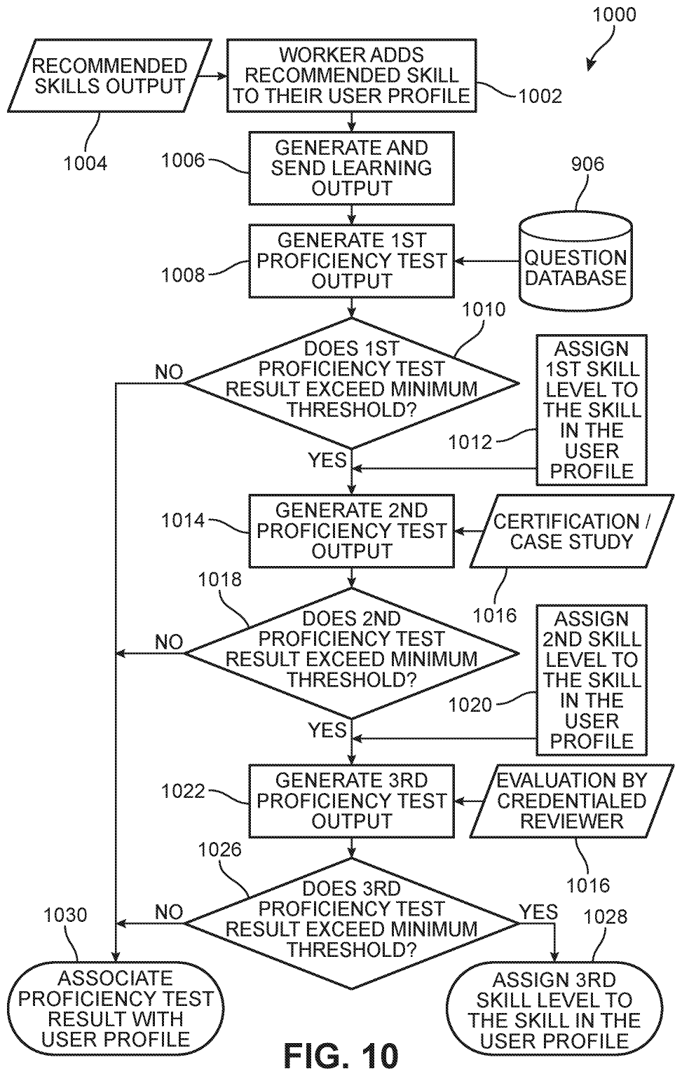

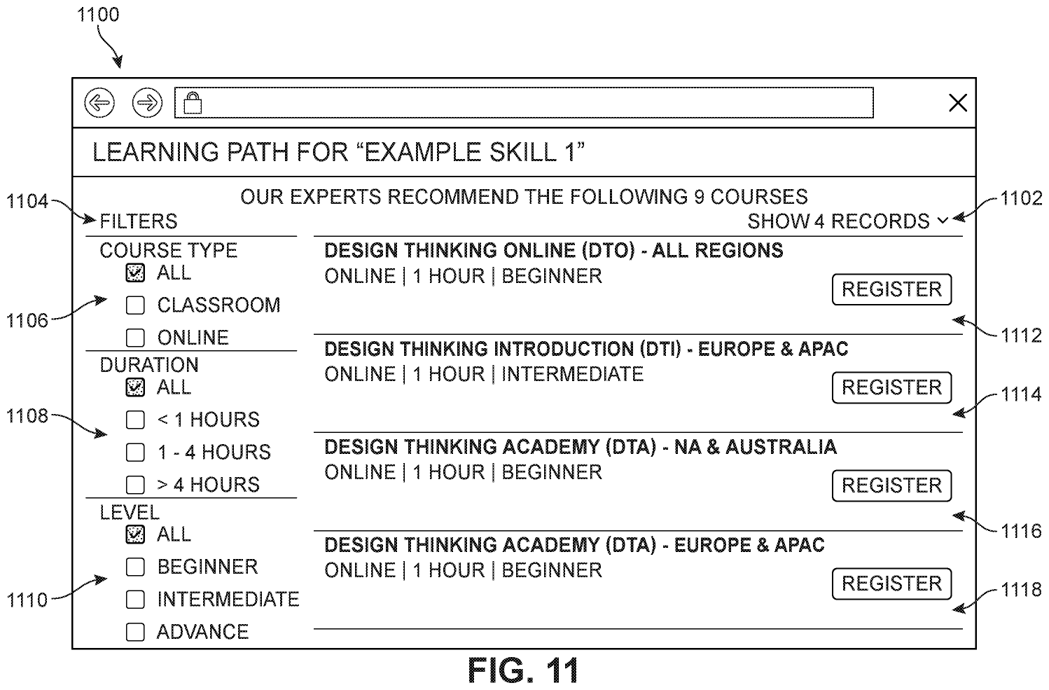

First, FIG. 1 shows an overview diagram of a system 100 (or artificial intelligence driven system for training and managing workers in a professional organization 100) in accordance with an embodiment of this disclosure. Generally, the system may include three main components that feed into one or more computing devices. For example, system 100 includes three main components: skill training component 102, skill proficiency testing component 104, and skill guidance component 106, which each feed into one or more computing devices 108. Skill training component 102 includes information descriptive of skill training. Skill training component 102 may describe training opportunities that allow a worker to advance a professional skill the worker already has. For example, skill training component 102 may describe a skill “path” along which a certain skill develops as the worker improves their proficiency in the skill—i.e. from beginning, to intermediate, to advanced. More detail about skill training component 102 may be found below with respect to FIGS. 10 and 11.

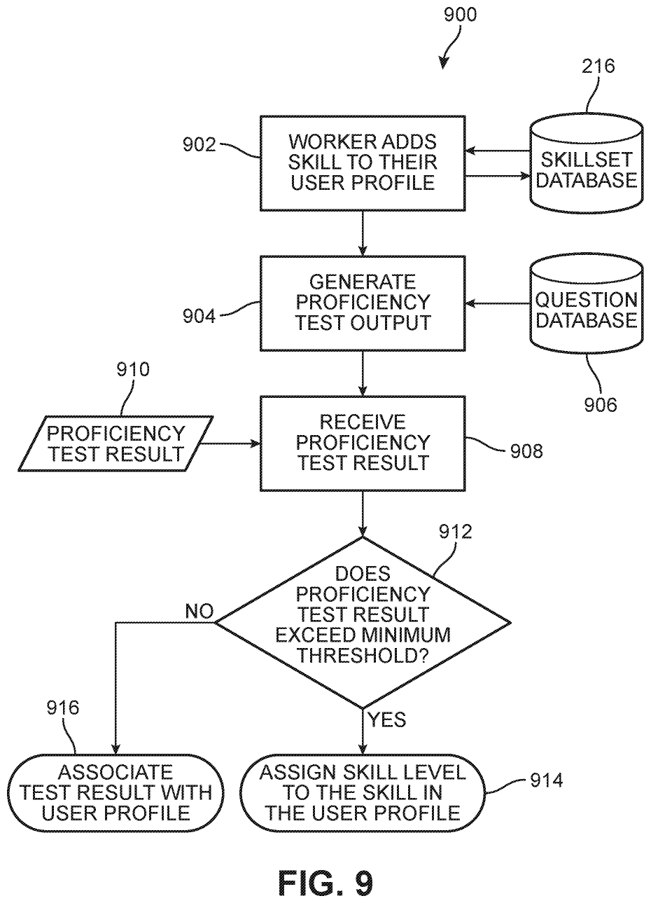

Skill proficiency testing component 104 includes information descriptive of one or more various types of skill proficiency testing. Namely, skill proficiency testing component 104 includes assessment tools for verifying that a worker has a particular professional skill. The proficiency testing may: come in various formats, be completed by the worker directly as a part of system 100 or offline from it, and draw from automated test building components, as described variously below with respect to FIGS. 9 and 10.

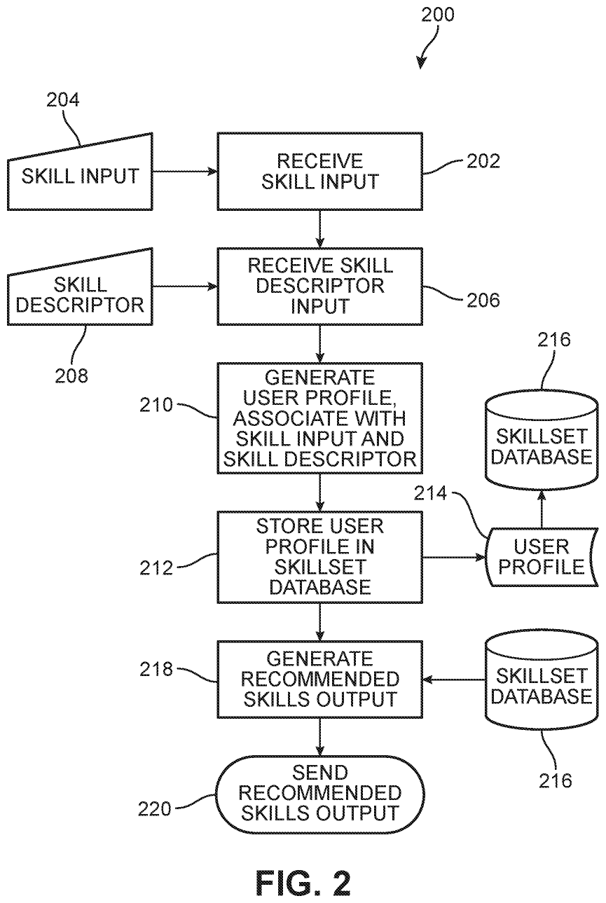

Skill guidance component 106 includes an artificial intelligence based skill guidance recommendation engine. Skill guidance component 106 generates recommendations of one or more professional skills that a worker may acquire. The skills guidance system within skill guidance component 106 is described in further detail below with respect to FIGS. 2-8.

The three components 102, 104, 106 are integrated into one single electronic platform by computing device 108. Broadly, computing device 108 may include one or more processors 110 and also a skillset database 112 that stores information about the workers and their associated professional skills. More detail about skillset database 112 is discussed below. Computing device 108 is generally configured to perform the various computing process steps as described herein.

In some embodiments, the computing device generates an interface that allows a user to interact with the system. For example, computing device 108 generates interface 114 that allows user 120 to interact with system 100. Interface 114 may be a web-based interface, such as an interactive web page. In some such embodiments, interface 114 may include login 116 that allows worker 120 to create a unique user profile with which to access system 100. In some embodiments, interface 114 may be a type of communication tool between management and workers—in that system 100 allows management to input certain parameters regarding certain types of skills (such as emerging skills, discussed below), and then workers may receive useful information in the form of outputs based on those parameters.

Of the three components 102, 104, 106, the first discussed herein is the skill guidance component 106. Generally, skill guidance component 106 uses artificial intelligence based analysis to find similarities in professional skills among a large dataset of workers in a professional organization, and uses those similarities to recommend which skills may be helpful to worker 120.

FIG. 2 shows more detail about how worker 120 interacts with system 100 and system 100 proceeds to operate. Specifically, in process 200 as shown in the flowchart of FIG. 2, system 100 first receives a skill input 204 at step 202. System 100 may receive skill input 204 from directly worker 120 via interface 114—or from another source, such as from management. Skill input 204 may be descriptive of a professional skill held by at least one worker in a professional organization. In specific embodiments, skill input 204 may include information that is descriptive of a professional skill held by worker 120. Skill input 204 may be in the form of one or more skills selected by worker 120 from a preexisting database of known skills (such as skillset database 216, described below), or may take the form of a descriptive input first created by worker 120.

Next, in step 206, process 200 includes a step of receiving a skill descriptor input 208. Skill descriptor input 208 may generally be any type of information that modifies, explains, or describes skill input 204. For example, skill descriptor input 208 may label skill input 204 as a “primary skill” or a “secondary skill” in order to indicate whether the skill in question is central to worker 120's job and career or peripheral to it. Other skill descriptors 208 may include whether the skill is currently at a proficiency level of beginner, intermediate, or advanced. A wide range of types of skill descriptors 208 may generally be used in process 200, in order to give each skill 204 held by worker 120 any useful or appropriate contextual information.

System 100 executing process 200 may then generate a user profile for worker 120 at step 210, if one does not already exist for worker 120. User profile 214 may be a digital representation of the information associated with the worker's skills and career. Namely, step 210 includes associating skill input 204 and skill descriptor 208 with user profile 214. Of course, if a user profile 214 already exists for worker 120 then skill input 204 and skill descriptor 208 are associated with the already existing user profile 214 at step 210. Process 200 next stores user profile 214 and its related data in a skillset database 216 at step 212. Process 200 may repeat steps 202 and 206 in embodiments where worker 120 may wish to input multiple skills or skill descriptors.

Skillset database 216 acts as a central repository for multiple user profiles—it includes user profile 214 corresponding to worker 120, as well as a number of multiple other additional user profiles. Namely, a large number of workers in a large professional organization may interface with system 100 and go through process 200 to each create a user profile that includes associated skill inputs 204 and skill descriptors 208. Skillset database 216 may therefore include an extremely large data set, that may be analyzed computationally to reveal patterns, trends, and associations among the workers and their professional skills.

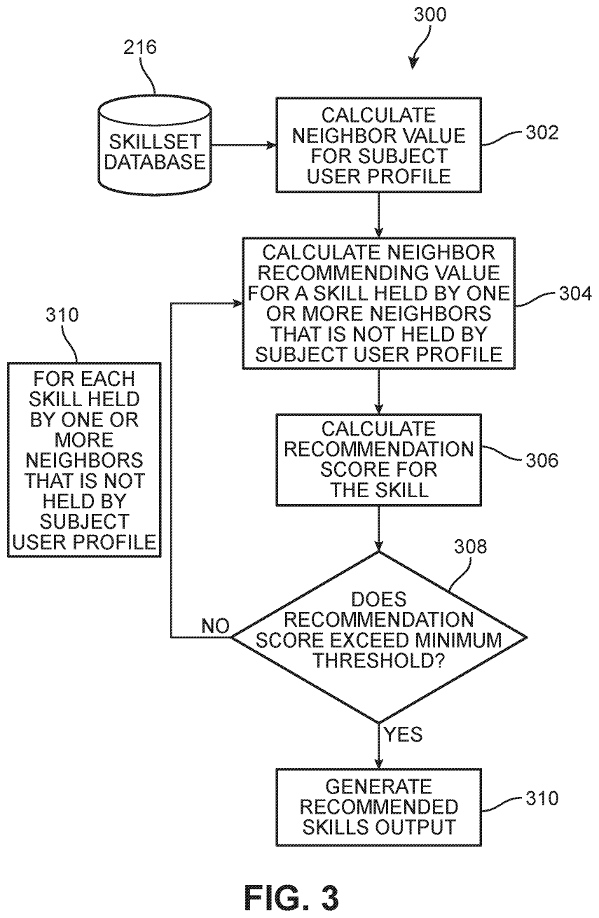

Specifically, in step 218 of process 200, system 100 may compare user profile 214 with the multiple additional user profiles in skillset database 216 to determine one or more recommended skills for the worker to acquire through training and add to their user profile. Step 218 of generating a recommended skills output is described in further detail below with respect to FIGS. 3-8. But generally, system 100 executes one or more models that analyze the skillset database to find patterns among the skills held by various users, in order to recommend to worker 120 one or more skills not already associated with user profile 214.

Finally, in a last step of process 200, system 100 sends the recommended skills output generated in step 218 to user 120 or other recipient at step 220. In this way, process 200 may provide to user 120 a recommendation for one or more new professional skills that user 120 may develop in order to further their career.

Of note, the above steps in process 200 are discussed above with respect to a certain ordered sequence of the steps (202, 206, 210, 212, 218, 220)—as is also shown in FIG. 2. However, in other embodiments, the various steps disclosed above may be conducted in other sequences. Additionally, other embodiments may include or exclude any one or more of the steps discussed, as may be necessary. This is also true throughout this disclosure, with respect to any process discussed herein.

FIG. 3 shows one particular way of comparing user profiles in the skillset database to generate a recommended skills output. Generally, ways of comparing the user profiles in the skillset database may be based on comparing the subject user profile 214 with the other, secondary, user profiles in the skillset data 216 that have at least the same primary skill in common. This category of determining the skills recommendation may be referred to as the “skills of similar employees” model.

As discussed above, whether a skill is a “primary” skill or not may be described by skill descriptor 208. Broadly, a primary skill held by a worker 120 may be the single most important professional skill to the worker 120's career. In some embodiments, therefore, each user profile in skillset database 216 may include at most one skill that is described as primary for the user profile. User profiles may then also include one or more secondary skills, that are peripheral to the primary skill in the worker's career and skills.

Process 300 as shown in FIG. 3 is one embodiment of step 218 in process 200 shown in FIG. 2. First step 302 includes drawing data from skillset database 216 to determine how many secondary user profiles have a certain minimum commonality with the subject user profile 214. This calculation generates a number of “neighbor” user profiles, so called because they share some degree of commonality with user profile 216 and so are “adjacent” to the user profile in some way. The total number of neighbor user profiles is assigned as the neighbor value.

In some embodiments of step 302 in process 300, the neighbor value may be based on user profiles that have only the same primary skill. For example, user profile 214 may have “coding” associated with it as the primary skill. Step 302 would then find all other user profiles in skillset database 216 that also have “coding” as the primary skill. The total number of these user profiles would then be the neighbor value. However, in other embodiments, a different similarity model may be used other than only the primary skill.

For example, in a second model, the number of neighbors may be calculated based on the number of secondary user profiles in the skillset database that have the same primary skill as user profile 214 and also have at least one secondary skill in common. This model would generally return fewer neighbors than the first model, based only the primary skill being held in common. This may be useful when the skillset database includes such a large set of data that using a tighter criteria for neighbor similarity might return results with higher relevancy to worker 120.

In yet another model for calculating the neighbor value in step 302, process 300 may determine the number of neighbors by comparing user profile 214 with all the secondary user profiles in skillset database 216 based on a similarity of a maximum number of skills held in common. This model may involve ranking all secondary user profiles according to a degree of similarity based on a maximum number of skills (primary or secondary) held in common, then applying a cutoff similarity value of (in some embodiments) 0.5. A cutoff value of 0.5 may be equivalent to having at least half of all skills in similar, as between the subject user profile 214 and the secondary user profile being compared. In other embodiments, a cutoff value of 0.4 may be used, or a cutoff value of 0.6, or 0.7.

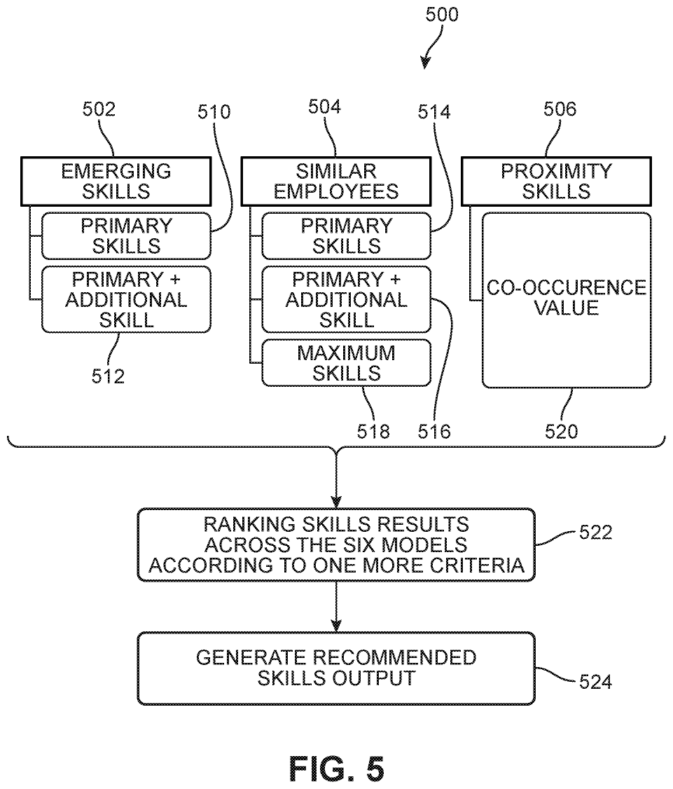

All secondary user profiles that have a similarity to user profile 214 above the cutoff may then be considered neighbors. More details about several models on which the neighbor value may be based are discussed below with respect to FIG. 5.

Next, in step 304, process 300 may include calculating a neighbor recommending value for each skill held by one or more secondary user profiles that are neighbors to the subject user profile 214 (and are not already associated with user profile 214). The neighbor recommending value may be based on the total quantity of neighbors that have the skill at issue. For example, user profile 214 may have a neighbor value per step 302 of 100—meaning that 100 secondary user profiles have (in one model) the same primary skill. Of these 100 neighbors, 60 of them may all have one new skill associated with them. The neighbor recommending value for the new skill would then be 60.

In step 306, process 300 may include calculating a recommendation score for each skill held by one or more of the neighbors. The recommendation score may be the ratio of the neighbor recommending value for each skill to the total neighbor value. In the example above, 60 neighbors have one skill in common out of 100 total neighbors—so the recommendation score for this skill is 0.6. Process 330 may include calculating whether the recommendation score exceeds a minimum threshold at step 308, in order to determine whether the skill at issue is relevant enough to output to the worker. In various embodiments, the minimum threshold for the recommendation score may be 0.3, or 0.4, or 0.5, or another value as may be determined to best narrow the results.

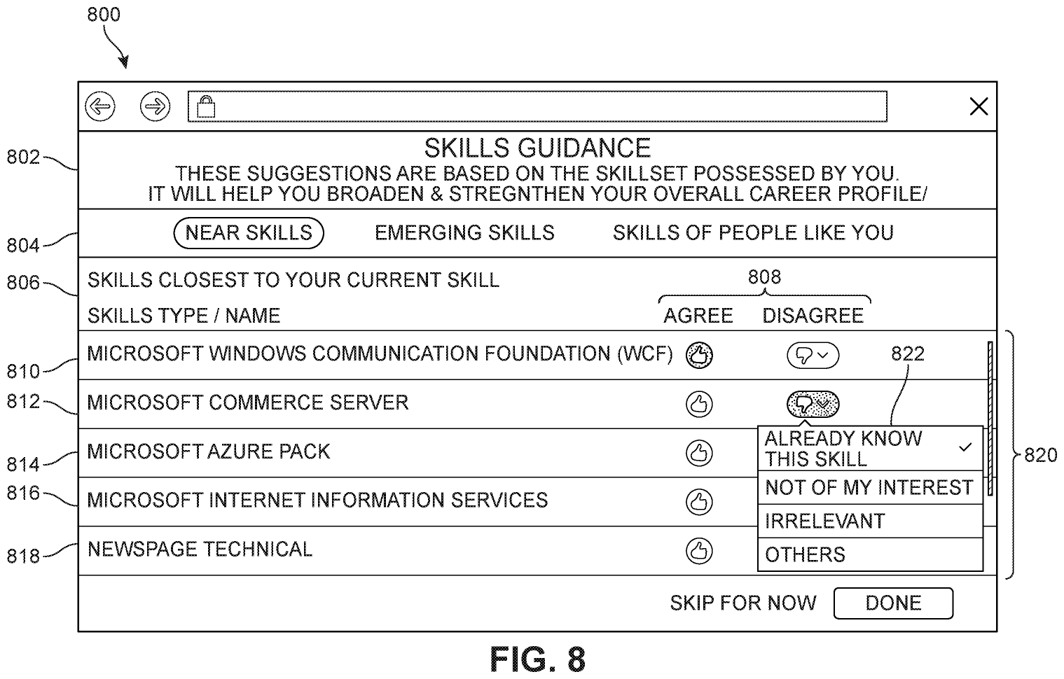

If the recommendation score exceeds the predetermined threshold, process 300 may proceed to step 310 of generating and sending a recommended skills output. The recommended skills output of step 310 may be sent to worker 120, or to management of the professional organization, or another recipient. As with other outputs discussed herein, recommended skills output of step 310 may be communicated to worker 120 via interface 114. Further discussion of this point is below with respect to FIG. 8.

The above several calculations, regressions, and analysis steps in process 200 and process 300 may be done by computing device 108—and may be referred to as a type of machine learning or artificial intelligence data processing. Most broadly, computing device 108 includes an artificial intelligence based system 100 that evaluates the large set of data in skillset database 112/216 to find trends, similarities, distinctions, and optimizations among the various professional skills held by workers in a large professional organization.

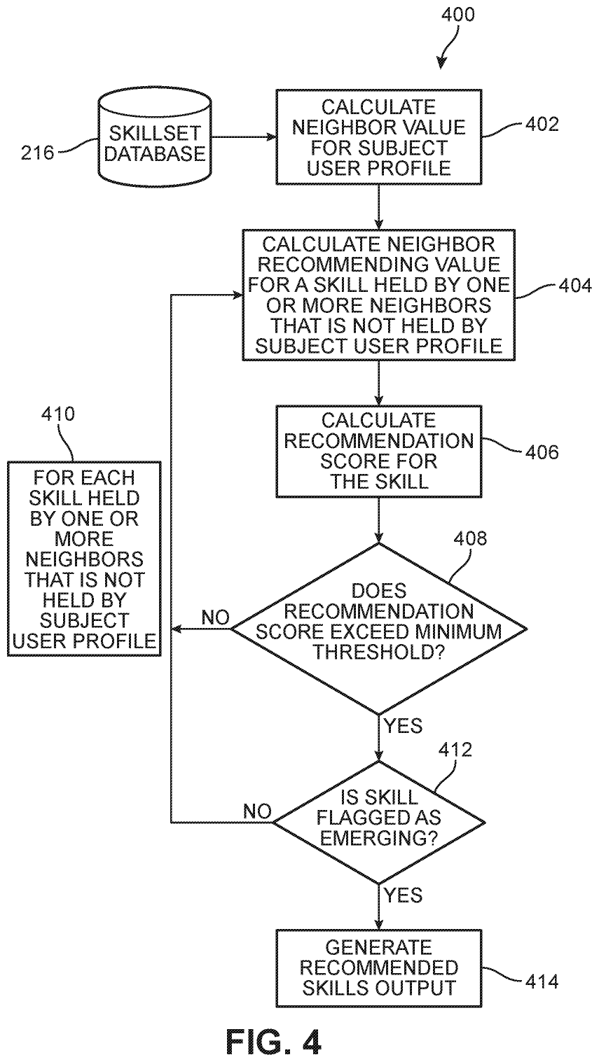

FIG. 4 shows another embodiment of step 218 in process 200 of generating the recommended skills output. In this embodiment, process 400 includes some similar steps to process 300 shown in FIG. 3 and discussed above. However, process 400 also includes analyzing at least one additional criteria among all the professional skills described by the data held in the skillset database 216.

Namely, a certain subset of all skills in skillset database 216 may be flagged as “emerging” skills. Emerging skills may be those skills that are the most cutting-edge professional skills within a professional organization—as determined by management of the professional organization, or by another deciding body. A skill may be flagged as emerging for a variety of reasons, such as: relation to a new project or customer, involvement in recent research and development efforts, or selected by automatic criteria as applied by using artificial intelligence to analyze trends within the skillset database 216. Process 400 may be referred to as the “emerging skills” model for determining the recommended skills output.

Namely, process 400 begins at step 402 of calculating the neighbor value for a subject user profile 214 by drawing data from the skillset database 216. Step 402 may be similar to step 302 in process 300. Second, step 404 may include calculating a neighbor recommending value for each skill held by one or more of the neighbors that is not already held by the subject user profile 214. Step 404 may be similar to step 304 in process 300. Next, at step 406 process 400 again calculates a recommendation score for each skill held by one or more neighbors. Step 406 may be similar to step 306 in process 300. Step 408 again applies a minimum score threshold to each skill—as was done in step 308 of process 300.

However, process 400 differs from process 300 at step 412. Step 412 involves filtering for skills that are flagged as emerging. Namely, in order to be included in the skills recommendation output created at step 414, a skill must be held by enough neighbors to achieve a minimum scoring and also be associated with the “emerging” descriptor. This step 412 will therefore more narrowly identify professional skills that might be helpful for the worker 120 to acquire. This may be helpful to worker 120 by identifying the most cutting-edge professional skills, that are not yet as widespread within the professional organization—allowing the worker opportunity to acquire the emerging skills in a time sensitive manner that might best promote the worker's career and the professional organization's strategic goals.

Within the emerging skills process 400, there may be more than one model for determining what constitutes a neighbor at step 402. As discussed above, in some embodiments, the neighbors may be defined as any secondary user profiles in the skillset database 216 that have only the same primary skill in common with the subject user profile 214. Alternatively, in other embodiments, neighbors may be defined as any secondary user profiles in the skillset database 216 having both the primary skill and also one secondary skill in common with the subject user profile 214.

Aside from the “skills of similar employees” model of process 300 and the “emerging skill” model of process 400, a third general model may also be used to generate a skills recommendation. Not otherwise shown in the figures, a third model for analyzing the skillset database may be referred to as the “proximity skills” or “near skills” model. In some embodiments, this model may be based on calculating a co-occurrence value between any two given pair of skills in the skillset database 216. The co-occurrence value may be the ratio of the number of secondary user profiles in the skillset database that include both of the two skills to the number of secondary user profiles in the skillset database that includes only a first one of the two skills.

For example, the co-occurrence value for skills “A” and “B” would be the number of user profiles in the skillset database with both skills A and B divided by the number of user profiles in the skillset database with only skill A. The co-occurrence value for any pair of two skills may be calculated with respect to either of the two skills—such as: (A+B)/(A) and also (A+B)/(B). In this way, the co-occurrence value measures the strength of how often two skills are found together in user profiles in the skillset database 216.

The near skills model then proceeds to rank the skills in the skillset database based on the co-occurrence value of each skill in relationship to the skills associated with the subject user profile 214. The system 100 then generates the recommended skills output, that includes a recommended skill when (a) the number of times the skill is associated with secondary user profiles in the skillset database exceeds a first predetermined threshold, and (b) the co-occurrence between the recommended skill and the skills associated with the user profile exceeds a second predetermined threshold. The first predetermined threshold may be at least 8 instances of the skill of the skillset database 216, or at least 10, or at least 20, or other threshold minimum value as may best narrow the results appropriately. The second predetermined threshold may be at least 0.3, or at least about 0.4, or at least about 0.5, or other threshold minimum value as may best narrow the results appropriately.

In another embodiment, a “near skills” model may be calculated using a predefined set of relationships among the skills in the skillset database that is external to the skillset database itself. For example, other calculations and analytics aside from those discussed above may be used to note certain valuable relationships between certain professional skills held by workers within the organization. These externally created sets of relationships may then be used to calculate which skills are proximate to any given skills held by the user.

As a result of the several models discussed above, system 100 may generate a recommended skills output that includes one or more professional skills that may be helpful to worker 120. In some embodiments, one of the above models (skills of similar employees model, emerging skills model, or proximity skills model) may be used to generate the recommended skills output. However, in other embodiments, a combination of one or more of these models may be used.

FIG. 5 shows a graphical representation of a process 500 for how multiple models may be used in combination to arrive at a final recommended skills output. Generally, process 500 may first include performing one or more processes like process 300 to calculate recommended skills using the similar employees model 504. This may include the ways of calculating neighbors within this model: primary skill only 514, primary and one secondary 516, and a maximum number of similar skills 518—all as discussed above.

Process 500 may next include performing one or more processes like process 400 to calculate recommended skills using the emerging skills model 502. As discussed above with respect to FIG. 4, the emerging skills model may define neighbors using either primary skill only 510, or primary skill plus one secondary skill 512.

Third, process 500 may include the proximity skills 506 which is generally based on a co-occurrence value 520, as discussed above.

As a result of the several above models, process 500 may include creating up to six sets of recommended skills and then combining the up to six sets. Namely, process 500 may include:

(1) creating a first set of recommended skills 514 by comparing the user profile with the secondary user profiles in the skillset database that have the same primary skill as the user profile;
(2) creating a second set of recommended skills 516 by comparing the user profile with the secondary user profiles in the skillset database that have the same primary skill and one secondary skill as the user profile;
(3) creating a third set of recommended skills 518 by comparing the user profile with the secondary user profiles in the skillset database that have the same primary skill and at least half of all skills as the user profile;
(4) creating a fourth set of recommended skills 510 by comparing the user profile with the secondary user profiles in the skillset database that have the same primary skill as the user profile, and are flagged as emerging skills;
(5) creating a fifth set of recommended skills 512 by comparing the user profile with the secondary user profiles in the skillset database that have the same primary skill and one secondary skill as the user profile, and are flagged as emerging skills; and
(6) creating a sixth set of recommended skills 520 by calculating a co-occurrence value between each skill associated with the user profile and each skill in the skillset database and ranking the skills in the skillset database based on the co-occurrence value.

Process 500 may then include a step 522 of ranking skills across the first, second, third, fourth, fifth, and sixth sets of recommended skills according to one or more criteria to generate a final list of recommended skills 524. The one or more criteria may include examples like: commonality of a result across multiple models, weighting of one model relative to another model, weighting of one neighbor calculation type (primary only vs. primary plus one secondary), absolutely priority of results from one model over another (e.g. emerging skills ranked first), and others.

Finally, a part of generating the recommended skills output in step 524, or step 414, or step 310, may include generating and sending description of the one or more models used to generate the recommended skills output. Namely, system 100 may display on interface 114 not only the substance of which skills are recommended—but also display information allowing worker 120 to understand why those skills were recommended. System 100 may therefore be considered an “explainable” artificial intelligence system, because the result is explainable to the end user.

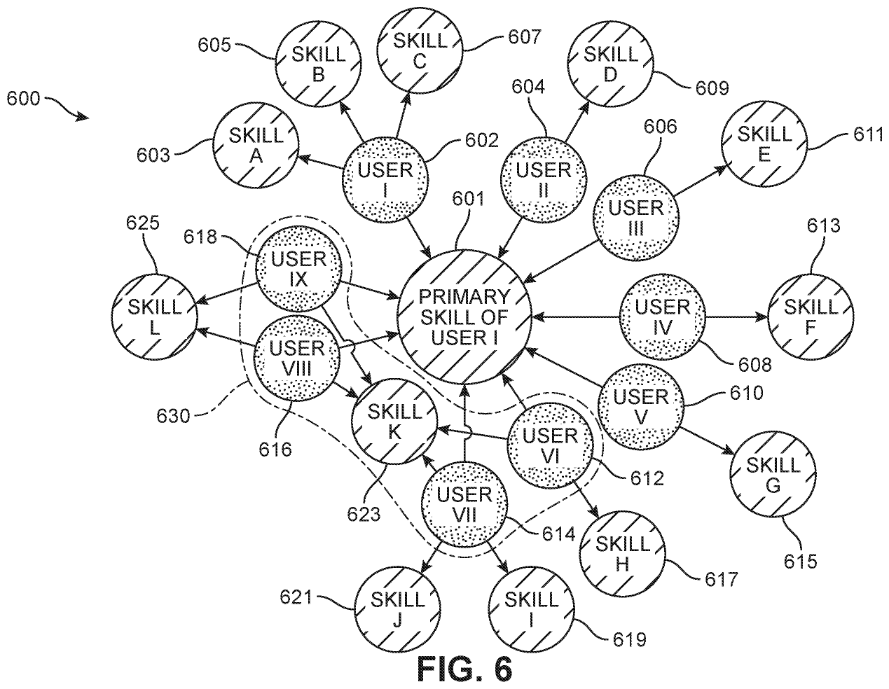

For example, FIG. 6 shows a graphical representation of a scatter diagram explaining why a skill might be recommended to a worker 120. The scatter diagram of FIG. 6 shows graphically a group of relationships among a set of data in skillset database 112/216.

Namely, FIG. 6 shows a subject user profile 214 “user I” 602 and a primary skill of user I 601 at the center. Neighbors of user I are shown as secondary users II through IX (604, 606, 608, 610, 612, 614, 616, 618). These secondary users are neighbors of user I because they share primary skill 601 in common, as discussed variously above. Next, these secondary users II through IX then also have other secondary skills, skill A through skill L. The relationships between each user and each skill are shown by the arrows connecting them. For example, subject user profile user I also has skill A 603, skill B, 605, and skill C 607.

Of note is that user VI 612, user VII 614, user VIII 616, and user IX 618 all share skill K 623. The graphical clustering of secondary users around skill K shows that this skill is held by a large number of similar employees. Therefore, according to the first calculation model discussed above (the similar employees model of FIG. 3 and process 300) skill K may be a recommended skill. Namely, user I has a neighbor value of eight (users II through IX) and a neighbor recommending value for skill K 623 of four. Skill K 623 therefore has a recommendation score of four divided by eight, or 0.5. A recommendation score of 0.5 is likely above a predetermined minimum threshold value, which is commonly set at 0.4. Therefore, process 300 will allow skill K 623 to pass and be a part of the recommend skills output 310.

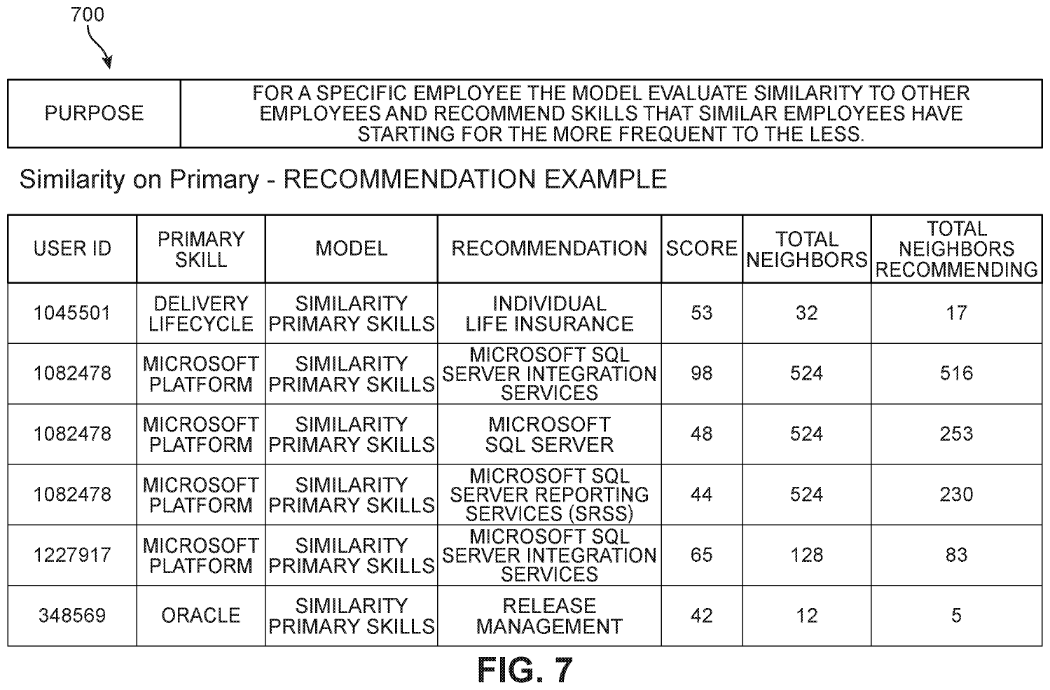

FIG. 7 shows a table of data that may be calculated as part of a process 300 that generates a recommend skills output. The data table of FIG. 7 shows a number of subject user profiles in the column labelled “user profile.” For each row, a recommendation result is shown. For subject user profile with ID number 1082478, three recommendations are shown. The number of neighbors for each subject user profile is shown in the “total neighbors” column. Then, for the recommended skill, the total neighbors recommending column shows the number neighbors that recommend that skill out of the total number of neighbors. From these two numbers, the recommendation score is calculated as discussed above. In this example, the recommending score is “total neighbors recommending”/“total neighbors”*100. Therefore, a minimum score may be 40. As shown, all of the results in the data table of FIG. 7 have a score of at least 40.

FIG. 8 shows a web interface of a recommended skills output 800 as it may appear on interface 114 to user 120. First, recommended skills output 800 includes explanation header 802, model selection option 804, and description row 806 at the top. Model selection option 804 may allow worker 120 to view various recommended skills output created by each model—and toggle back and forth to compare them against each other. Recommended skill 1 810, recommended skill 2 812, recommended skill 3 814, recommended skill 4 816, and recommended skill 5 818 are each listed on a row. Also on each row is an input option 808 that allows worker 120 to agree or disagree with the recommendation. In some embodiments, the “agree” option may add the recommended skill to the worker's user profile. The “disagree” option may include a popup option box 822 that allows worker 120 to provide feedback so that system 100 may generate even better recommendations in the future.

Therefore, in this way, as discussed at length above, the skill guidance component 106 of the digital platform system 100 uses explainable artificial intelligence to provide insights into career skill trends within a professional organization as they relate to a particular user.

Next, skill proficiency testing component 104 may also be incorporated into system 100. Skill proficiency testing allows worker 120 to verify that they do, in fact, possess a given professional skill. Proficiency testing may also allow a worker to catalogue and advertise their level of understanding of a skill. This may allow a worker to better advance their career, by allow them to match themselves to certain projects or customers—or by allowing management of the professional organization to so match them.

FIG. 9 shows a flowchart of an example process 900 including skills proficiency testing. In process 900, a worker 120 first adds a particular skill to their user profile at step 902. Process 900 interfaces with skillset database 216 at step 902, by storing the added skill as associated with the user profile. Process 900 next generates a proficiency testing output at step 904. Proficiency test output may generally be descriptive of a proficiency test corresponding to the newly added professional skill.

In some embodiments, proficiency test output as generated at step 904 may generally be information that is descriptive of, or otherwise associated with, a proficiency test—but not the substance of the test itself. For example, proficiency test output may be comprised of information such as: test description, test location, test time, or test level (beginner, intermediate, advanced, etc.).

However, in other embodiments, proficiency test output may comprise a proficiency test itself. Particularly, proficiency test output may comprise a proficiency test selected from the group consisting of: automated question-and-answer format drawn from pre-written questions, certifications, case studies, hands on tests, and evaluation by a credentialed reviewer. In such embodiments, step 904 may draw from a question database 906 to automatically build the proficiency test.

Namely, in some embodiments, the proficiency test may be an automated question-and-answer format questionnaire that is built by system 100 by drawing information from question database 906. Specifically, computing device 108 may generate the proficiency test by selecting multiple questions from a question database based on question meta-data. Question meta-data may be descriptive of one or more of each question's associated skill, complexity, average time spent on the question, history of usage in past proficiency tests, and others as may be appropriate. The various processes used to build a proficiency test in this way may be another example of artificial intelligence being used in system 100 to develop workers' professional skills.

Back to FIG. 9, in step 908 process 900 may receive a proficiency test result 910. In embodiments where step 904 generate the proficiency test itself, step 908 may include directly receiving a series of answer inputs from the worker, each answer input corresponding to a respective question in the proficiency test. Namely, step 908 may allow worker 120 to take the proficiency test direct on interface 114 as part of system 100. Therefore, as worker 120 answers each question in the proficiency test, the answer is received by process 900 and the total test result 910 is therefore automatically calculated.

However, in other embodiments, worker 120 may receive the proficiency test output at step 904 and then take the actual proficiency test offline from system 100. In such embodiments, system 100 may then receive the proficiency test result 910 via e.g. a manual upload to computing device 108.

Process 900 next includes comparing the result of the proficiency test to a predetermined threshold at step 912. The predetermined threshold may vary according to a variety of factors and may be automatically generated by system 100 in embodiments where the proficiency test was an automated question-and-answer format questionnaire built by system 100 as described above. Alternatively, in other embodiments, the predetermined threshold for the result of the proficiency test may be manually entered by management of the professional organization.

When the result of the proficiency test exceeds the predetermined threshold, the worker is considered to have passed the test. In step 914, process 900 associates the result of the proficiency test with the workers user profile and also assigns a skill level to the skill in the user profile to signify that the worker has achieved a certain level of master of the skill. In contrast, if the result of the proficiency test is below the predetermined threshold then merely the test result is associated with the user profile at step 916.

FIG. 10 shows another embodiment of a process 1000 relating to the skill proficiency testing component 104 of system 100. Process 1000 generally includes multiple proficiency tests that come in various forms, and also includes a learning output to incorporate skill training component 102.

Namely, in a first step 1002 process 1000 allows worker 120 to add a recommended skill 1004 to their user profile. Process 1000 therefore also incorporate the skills guidance recommendation engine, as discussed variously above. In this context, the recommended skills output (310, 414, 524) that is the result of the skills guidance process (300, 400, 500) in turns becomes the skill input 1004 that starts process 1000 at step 1002. In this way, the skill guidance component 106 of system 100 works integrally with the other aspects of the artificial intelligence based system for managing workers.

Process 1000 includes three steps of generating proficiency test outputs. In step 1008, process 1000 generates a 1^{st} proficiency test output. First proficiency test output may be an automatically generated question-and-answer format proficiency test that draws from question database 906, as discussed above. If the first proficiency test result exceeds a first minimum threshold, process 1000 proceeds to generating a second proficiency test output. Meanwhile, process 1000 also assigns a first skill level to the skill in the user profile. Otherwise, if the first proficiency test result does not exceed the first minimum threshold, process 1000 terminates at step 1030 and associates the first proficiency test result with the user profile. In this way, passing a test allows the worker to verify mastery of the skill at a certain level through the skill level assigned to their user profile.

At step 1014 of generating the second proficiency test out, the second proficiency test may be a certification or case study. This proficiency test may be integrated with system 100 or offline from it. Next, at step 1018 process 1000 again compares the most recent test result (the second proficiency test result) to a second minimum threshold. Again, if the worker passed, the process 1000 proceeds to generate a next, third, proficiency test output at step 1022. The third proficiency test 1016 may be in a format of evaluation by a credential reviewer. In this way, process 1000 may include a variety of formats for the multiple proficiency tests included therein. These formats may allow a worker to best demonstrate and verify their knowledge of a skill in various contexts and under different testing conditions.

In some embodiments, the first proficiency test output may be referred to as an objective assessment because it is an automatically generated question-and-answer format test that establishes a first base level of skill. The second proficiency test may then be referred to as an expert assessment, as it involves a more complicated proficiency test in form of a certification or case study that establishes a higher level of proficiency in the skill. Finally, the third proficiency test may be referred to a master assessment because it requires the most complicated form of proficiency test, and establishes a highest level of proficiency in the skill.

As mentioned, process 1000 also includes step 1006 of generating and sending a learning output. Learning output is an example of skill training component 102, the other one of the three major components (102, 104, 106) in system 100. Generally, the learning output may be descriptive of one or more training opportunities that correspond to a professional skill. In the context of process 1000, learning output may relate to the skill that is the subject of recommended skills output/input 1004. Learning output may allow worker 120 to received knowledge and training that would prepare them for a proficiency test, such as one or more of the three proficiency tests in process 1000.

Broadly, worker 120 may advance their knowledge of their existing skill through skill training component 102 of the digital platform system 100. The skill training component 102 provides to the worker 120 a path for developing one or more existing skills associated with the workers users profile 214. This section of the digital platform may include information such as recommended training courses for a given existing skill. Descriptions of the training course may also be provided, such as a skill level that the course is addressed to (beginner, intermediate, advanced), a mode of learning (virtual, class room), and a duration of the training course. By consuming the training courses along a skill path for an existing skill, a user may progress and improve that skill.

As with the proficiency test output, learning output may in some embodiments be data that is associated with of one or more training opportunities—and in other embodiments may be the substance of one or more training courses itself. In either embodiment, the learning output may also include training meta-data that is descriptive of the one or more training opportunities. Training meta-data may be selected from the group consisting of: mode of learning, duration of the training, skill level, and combinations thereof.

FIG. 11 shows an example of a learning output 1100 as displayed on interface 114 as a webpage. Learning output 1100 may include header display options 1102, and filter options 1104 to narrow the output based on criteria corresponding to training meta-data. Specifically, learning output 1100 includes selection criteria on course types 116, duration 1108, and skill level 1110. Example learning opportunities 1112, 1114, 1116, and 1118 are then displayed—and a link to register for each training opportunities.

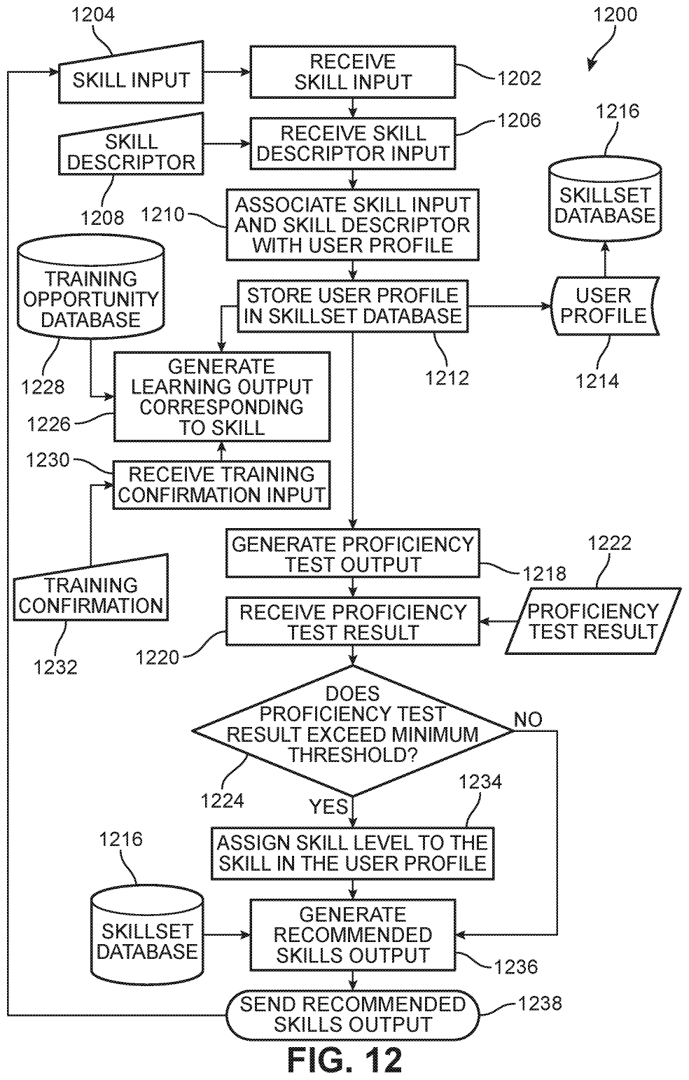

Finally, FIG. 12 shows a flowchart of an embodiment of a process in accordance with this disclosure that shows how the several main components 102, 104, 106 may work together to seamlessly enhance worker professional skills. Similar in some respects to flowcharts shown in other FIGS. and discussed above, process 1200 also includes integration between proficiency testing, learning output describing training opportunities, and the skills recommendation models.

Namely, process 1200 includes first step 1202 of receiving a skill input 1204, then receiving a skill descriptor 1208 at step 1206, then associating the skill input 1204 and skill descriptor 1208 with a user profile at step 1210, and storing the user profile 1214 in skillset database 1216 at step 1212. These steps may be substantially similar to steps 202, 206, 210, 212 in process 200 respectively.

In a side option available to the user once their user profile 1214 with associated skill is stored in the skillset database 1216, the embodiment shown in FIG. 12 also includes step 1226 of generating a learning output corresponding to the professional skill that was the subject of steps 1202, 1204, etc. Step 1226 may draw on training opportunity database 1228 that includes data descriptive of one or more training opportunities. Generally, training opportunity database 1228 may include data descriptive of any of the learning options shown in FIG. 11 discussed above. Process 1200 may also include step 1230 of receiving a training confirmation input as part of the side option related to the learning output 1226. Namely, step 1230 includes receiving the training confirmation 1232.

Generally, features 1226, 1228, 1230, and 1232 work together to provide the user with skill training opportunities and confirmation that the user has learned from those opportunities to develop their already existing skills. The user may generally participate in these side option learning steps at any time after a skill has been associated with their user profile 1214 in the skillset database 1216. In this way, in process 1200 the user may receive a learning output, engage in the learning opportunity to train themselves on the skill, and generate the training confirmation to confirm to process 1200 that they have completed the training.

Step 1212 may then proceed to step 1218 of generating a proficiency test output. Process 1200 may then generate a proficiency test output at step 1218, and receive back a proficiency test result 1222 at step 1220, similar to steps 904 and 908 of process 900. Thus, the proficiency testing component 104 thereby verifies that a user has successfully mastered a skill. For example, a user may develop their knowledge of a skill through an optional learning opportunity described in 1226, and then test that knowledge at 1218. Process 1200 therefore allows users to build professional skill competency by offering skill training 102 and sill proficiency testing 104 together on one platform.

Otherwise, process 1200 next also includes step 1234 of assigning a skill level to the skill at issue in the user profile if the proficiency test was passed at step 1224. Subsequently, process 1200 may generate a recommended skills output at step 1236 by drawing from the skillset database (as described variously above). In the final step 1238, process 1200 sends the recommended skills output to worker 120. However, in this embodiment, the recommended skills output generated in step 1238 may become the skill input 1204 used in step 1202. This iterative process may allow worker 120 to input their professional skills, verify their proficiency with each skill through testing, receive training opportunities to increase their knowledge of their existing skills, and add new skills to their career development.

In this way, each worker within a professional organization may organize their existing career related skills, learn more about those skills, and verify that they have those skills—all within the digital platform system 100.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. An artificial intelligence driven system for training and managing workers in a professional organization, the system comprising at least one computing device, the computing device including a processor; and wherein the computing device is configured to perform the steps of:
receiving a skill input descriptive of a professional skill held by at least one worker;
associating the skill input with a user profile for the at least one worker;
storing the skill input as associated with the user profile in a skillset database, the skillset database including multiple additional user profiles with respective associated skill inputs;
providing a proficiency test output descriptive of a proficiency test corresponding to the professional skill inputted;
receiving a result of the proficiency test and associating the result of the proficiency test with the user profile;
comparing the user profile with the multiple additional user profiles in the skillset database to determine one or more recommended skills for the worker to add to their user profile; and
sending an output to the worker of the one or more recommend skills.

2. The system of claim 1, wherein
the step of sending a proficiency test output descriptive of a proficiency test includes sending a proficiency test selected from the group consisting of: automated question-and-answer format drawn from pre-written questions, certifications, case studies, hands on tests, and evaluation by a credentialed reviewer.

3. The system of claim 1, wherein the computing device is further configured to perform the steps of:
associating a skill level with the skill input received from the worker in the user profile in the skillset database, the skill level being descriptive of a level of proficiency related to the skill;
sending a first proficiency test output to the worker descriptive of a first proficiency test;
receiving a first result corresponding to the first proficiency test, and associating a first skill level with the skill input in the user profile when the first result exceeds a first predetermined threshold;
sending a second proficiency test output to the worker descriptive of a second proficiency test;
receiving a second result corresponding to the second proficiency test, and associating a second skill level with the skill input in the user profile when the second result exceeds a second predetermined threshold;
sending a third proficiency test output to the worker descriptive of a third proficiency test; and
receiving a third result corresponding to the third proficiency test, and associating a third skill level with the skill input in the user profile when the third result exceeds a third predetermined threshold.

4. The system of claim 1, wherein:
the proficiency test is an automated question-and-answer format questionnaire;
and the computing device is further configured to perform the steps of:
generating the proficiency test by selecting multiple questions from a question database based on question meta-data, wherein the question meta-data is descriptive of one or more of each question's associated skill, complexity, average time spent on the question, and history of usage in past proficiency tests; and
receiving a series of answer inputs from the worker, each answer input corresponding to a respective question in the proficiency test.

5. The system of claim 1, wherein:
the proficiency test is conducted offline from the system for training and managing workers;
and the computing device is further configured to perform the steps of:
receiving a result of the proficiency test through an upload to the system for training and managing workers;
comparing the result of the proficiency test to a predetermined threshold;
calculating a proficiency rating value, when the result of the proficiency test exceeds the predetermined threshold; and
associating the proficiency rating value with the user profile.

6. The system of claim 1, wherein the computing device is further configured to:
receive a skill descriptor input for each skill input, descriptive of whether the skill inputted is a primary skill or a secondary skill;
associate the skill descriptor with each skill in the user profile, as stored in the skillset database;
and wherein the step of comparing the user profile with the multiple additional user profiles in the skillset database includes comparing the user profile to other user profiles that have the same primary skill.

7. A method of using artificial intelligence for training and managing workers in a professional organization, the method comprising:
receiving from a worker a skill input, descriptive of a professional skill held by the worker;
receiving from the worker a skill descriptor input from the worker for each skill input, descriptive of whether the skill inputted is a primary skill or a secondary skill;
generating a user profile for the worker, and associating the skill input and skill descriptor with the user profile;
storing the user profile in a skillset database, the skillset database further including multiple secondary user profiles as their associated skill inputs and skill descriptors;
sending a proficiency test output to the worker, descriptive of a proficiency test corresponding to the professional skill inputted;
receiving a result of the proficiency test and associating the result of the proficiency test with the user profile;
generating and sending a learning output to the worker, the learning output being descriptive of one or more training opportunities corresponding to the professional skill;
generating a recommended skills output by comparing the user profile with the secondary user profiles in the skillset database that have the same primary skill as the user profile; and
sending the recommended skills output to the worker.

8. The method of claim 7, wherein the step of generating and sending a learning output to the worker further includes:
accessing a training opportunity database, the training opportunity database including data descriptive of one or more training opportunities; and
selecting one or more training opportunities from the training opportunity database;
wherein the learning output includes information corresponding to the one or more selected training opportunities.

9. The method of claim 7, wherein:
the learning output includes training meta-data selected from the group consisting of: mode of learning, duration of the training, skill level, and combinations thereof.

10. The method of claim 7, wherein the step of generating the recommended skills output further includes:
calculating a neighbor value based on a total quantity of secondary user profiles in the skillset database that have the same primary skill as the user profile;
calculating a neighbor recommending value for each skill held by one or more secondary user profiles in the skillset database that have the same primary skill as the user profile, the neighbor recommending value being based on the quantity of secondary user profiles having each such skill;
calculating a recommendation score for each skill based on the ratio of the neighbor recommending value for said skill to the neighbor value; and
generating the recommended skills output, that includes a recommended skill when the recommendation score for the skill exceeds a predetermined threshold.

11. The method of claim 7, wherein the method further includes steps of:
receiving a new skills input from the worker, the new skills input being made up of one or more skills described in the recommended skills output;
associating the new skills input with the user profile;
sending a new skill proficiency test output to the worker, descriptive of a new proficiency test corresponding to one of the skills in the recommend skills output contained in the new skills input; and
generating and sending a new skill learning output to the worker, the new skill learning output being descriptive of training opportunities corresponding to the one of the skills in the recommend skills output contained in the new skills input.

12. The method of claim 11, wherein:
the new proficiency test is an automated question-and-answer format questionnaire;
and the computing device is further configured to perform the steps of:
generating the new proficiency test by selecting multiple questions from a question database based on question meta-data, wherein the question meta-data is descriptive of one or more of each question's associated skill, complexity, average time spent on the question, and history of usage in past proficiency tests; and
receiving a series of answer inputs from the worker, each answer input corresponding to a respective question in the proficiency test.

13. The method of claim 7, wherein the step of sending the recommended skills output to the worker further includes:
sending to the worker a description of a model used to generate the recommend skills output.

14. One or more non-transitory computer readable storage media encoded with instructions that, when executed by a processor of a computing device, causes the processor to:
receive a skill input, descriptive of a professional skill held by at least one worker;
receive a skill descriptor input from the worker for each skill input, descriptive of whether the skill inputted is a primary skill or a secondary skill;
generate a user profile for the worker, and associate the skill input and skill descriptor with the user profile;
store the user profile in a skillset database, the skillset database further including multiple secondary user profiles as their associated skill inputs and skill descriptors;
generate a recommended skills output by comparing the user profile with the secondary user profiles in the skillset database that have the same primary skill as the user profile, the recommended skills output being descriptive of one or more skills not already associated with the user profile; and
send the recommended skills output to the worker.

15. The non-transitory computer readable storage media of claim 14, wherein the step of generating the recommended skills output further includes:
calculating a neighbor value based on a total quantity of secondary user profiles in the skillset database that have the same primary skill as the user profile;
calculating a neighbor recommending value for each skill held by one or more secondary user profiles in the skillset database that have the same primary skill as the user profile, the neighbor recommending value being based on the quantity of secondary user profiles having each such skill;
calculating a recommendation score for each skill based on the ratio of the neighbor recommending value for said skill to the neighbor value; and
generating the recommended skills output, that includes a recommended skill when the recommendation score for the skill exceeds a predetermined threshold.

16. The non-transitory computer readable storage media of claim 14, wherein the skillset database includes multiple skills inputs that are flagged as emerging skills;
and the step of generating the recommended skills output includes:
calculating a neighbor value based on a total quantity of secondary user profiles in the skillset database that have the same primary skill as the user profile;
calculating a neighbor recommending value for each skill held by one or more secondary user profiles in the skillset database that have the same primary skill as the user profile, the neighbor recommending value being based on the quantity of secondary user profiles having each such skill;
calculating a recommendation score for each skill based on the ratio of the neighbor recommending value for said skill to the neighbor value; and
generating the recommended skills output, that includes a recommended skill when the recommendation score for the skill exceeds a predetermined threshold and the skill is flagged as an emerging skill.

17. The non-transitory computer readable storage media of claim 14, wherein the step of generating the recommended skills output includes:
calculating a co-occurrence value between each pair of two skills in the skillset database, the co-occurrence value being the ratio of the number of secondary user profiles in the skillset database that include both of the two skills to the number of secondary user profiles in the skillset database that includes only a first one of the two skills;
ranking the skills in the skillset database based on the co-occurrence value of each skill in relationship to the skills associated with the user profile;
generating the recommended skills output, that includes a recommended skill when (a) the number of times the skill is associated with secondary user profiles in the skillset database exceeds a first predetermined threshold, and (b) the co-occurrence between the recommended skill and the skills associated with the user profile exceeds a second predetermined threshold.

18. The non-transitory computer readable storage media of claim 14, wherein the step of generating the recommended skills output includes:
comparing the user profile with the secondary user profiles in the skillset database that have the same primary skill as the user profile and also have one secondary skill in common with the user profile.

19. The non-transitory computer readable storage media of claim 14, wherein the step of generating the recommended skills output includes:
comparing the user profile with the secondary user profiles in the skillset database that have the same primary skill as the user profile and also have multiple secondary skills in common with the user profile;
ranking one or more skills not associated with the user profile by how often they appear among a set of secondary user profiles that share at least half of their skills in common with the user profile;
generating the recommended skills output, that includes one or more of the skills having a highest ranking.

20. The non-transitory computer readable storage media of claim 14, wherein the step of generating a recommended skills output includes:
creating a first set of recommended skills by comparing the user profile with the secondary user profiles in the skillset database that have the same primary skill as the user profile;
creating a second set of recommended skills by comparing the user profile with the secondary user profiles in the skillset database that have the same primary skill and one secondary skill as the user profile;
creating a third set of recommended skills by comparing the user profile with the secondary user profiles in the skillset database that have the same primary skill and at least half of all skills as the user profile;
creating a fourth set of recommended skills by comparing the user profile with the secondary user profiles in the skillset database that have the same primary skill as the user profile, and are flagged as emerging skills;
creating a fifth set of recommended skills by comparing the user profile with the secondary user profiles in the skillset database that have the same primary skill and one secondary skill as the user profile, and are flagged as emerging skills;
creating a sixth set of recommended skills by calculating a co-occurrence value between each skill associated with the user profile and each skill in the skillset database, and ranking the skills in the skillset database based on the co-occurrence value; and
ranking skills across the first, second, third, fourth, fifth, and sixth sets of recommended skills according to one or more criteria to generate a list of recommended skills.
